(19) United States
(12) Patent Application Publication
(10) Pub. No.: US 2010/0203835 A1
(43) Pub. Date: Aug. 12, 2010

(54) Wireless Network Protocol for Converging Braodcasting, Communication and Controlling In a Short Ranged Pico-Cell

(75) Inventors: Seung-Moon Ryu, Gyeonggi-do (KR); Wan-Gyu Ju, Gyeonggi-do (KR); Hae-Young Cho, Gyeonggi-do (KR); Jae-Hyun Eom, Seoul (KR)

Correspondence Address: EDWARDS ANGELL PALMER & DODGE LLP, P.O. BOX 55874, BOSTON, MA, 02205, US

(73) Assignee: CASUH CORPORATION, Seongnam, Gyeonggi-do (KR)

(21) Appl. No.: 12/513,242

(22) PCT Filed: Nov. 2, 2007
(86) PCT No.: PCT/KR07/05509

§ 371 Date: May 31, 2009

(30) Foreign Application Priority Data
Nov. 3, 2006 (KR) 10-2006-0108313

(51) Int. Cl. H04B 7/00

(52) U.S. Cl. 455/41.2

(57) ABSTRACT

In wireless devices for transmitting/receiving at least one of broadcasting, communication and controlling, a wireless network protocol transmits repeatedly data structure with a certain period in a unit of the same cycle, and maintains synchronization of the devices in a unit of the same cycle. As a result, a frequency hopping is performed in a unit of a cycle. Here, length of the cycle is set to below 20 msec so that a buffer used for transmitting/receiving a broadcasting signal and a voice/data communication has length of below 20 msec. Cycles form a network cycle. Control frames included in the cycles in the network cycle are differently assigned in accordance with their use, and so the control frames may be used for various controls. A payload frame in the cycle used by a user may be set freely in the range of length of the cycle. In addition, the user may set optionally transmission direction, transmission velocity, transmission output power, etc in a unit of a frame and use the buffer in a unit of the frame. As a result, a user interface may be set simply.

### TECHNICAL FIELD

Example embodiments of the present invention relate to a protocol for converging broadcasting, communication and controlling between wireless devices in a pico-cell having a radius of less than 10 m.

### BACKGROUND ART

Recently, one device having multi-function is developed by converging devices having simple function according as a telecommunication technique has been grown. For example, a portable phone has an mp3 player function, a satellite DMB function and a terrestrial DMB function. That is, communication and broadcasting has been converged in the portable phone.

In addition, high speed transmission line is set in a lot of houses according as an Internet is generalized. Hence, a multimedia over IP (hereinafter, referred to as “MoIP”) communication function and an Internet protocol television (hereinafter, referred to as “IPTV”) broadcasting function may be embodied through the same transmission line. Accordingly, a user wants service where communication and broadcasting are converged.

However, the communication and the broadcasting have been individually developed by now, and so a first protocol used for the communication is different from a second protocol used for the broadcasting. Hence, the protocols are not compatible. Specially, the communication and the broadcasting use different frequency, and thus a device having the communication function and the broadcasting function should include individually a communication system and a broadcasting system, wherein the systems have different constitution.

If the constitution of the communication system and the constitution of the broadcasting system are unified, a service of converging the broadcasting and the communication may be embodied with using one system. Accordingly, the convenience of a user will be enhanced.

In fact, a method of converging the broadcasting and the communication is very complicated. However, the method means simple convergence of for example a wireless telephone and a radio receiver in view of a user.

Here, since a frequency and a protocol of the wireless telephone are different from those of the radio receiver, a method of including individually the broadcasting system and the communication system having different constitution in one device is used. However, there is limit of the present technique in that the convergence of the broadcasting and the communication could not be embodied as other method except the above method.

So far, users think that a wireless stereo headset is a gadget of a TV or a wireless MP3 player, etc. However, the wireless stereo headset may be thought as an interactive radio for receiving a local area broadcasting signal which is a wireless audio signal. In this case, a mini terminal for converging the wireless stereo headset and a wireless phone will be regarded as a terminal for converging the broadcasting and the communication.

In case that a technique for converging function of a remote controller used when a user controls a TV or an audio device at home, function of a wireless phone and function of a wireless stereo headset will be developed, the user may answer a call with listening to music when the call is received during listening to music using the terminal at home or control a surrounding device with answering the call and listening to music at home. As a result, the terminal for converging the broadcasting, the communication and the remote-controlling in a pico-cell having a radius of less than 10 m may be developed. Hence, if the wireless stereo headset, the wireless phone and the remote controller use the same frequency, a problem that frequencies are varied in accordance with applications will be solved.

Accordingly, development of a protocol for converging the broadcasting, the communication, and the remote-controlling in the pico-cell has been required. For example, development of a terminal having a system which uses one unified protocol for the broadcasting, the communication and the remote-controlling has been required.

Hence, to embody an audio broadcasting, a voice call and a data communication for control with one system in the pico-cell, a frequency and a protocol capable of meeting transmission velocity, delay time and transmission quality in corresponding applications should be ensured.

Since 2.4 GHz frequency band and a 5.7 GHz frequency band are used without license throughout the world, a digital audio signal requiring fastest velocity is transmitted in the frequency bands. Hence, a voice communication and a data communication having transmission velocity smaller than transmission of the digital audio signal may be embodied in the frequency bands.

Hence, development of a protocol which meets the broadcasting, the communication and the remote-controlling requiring different characteristics and prevents interference therebetween has been required. Here, the broadcasting requires high speed transmission velocity, transmits a broadcasting signal in real time, and has characteristic that a number of users is not limited because the broadcasting signal is openly transmitted. The voice communication and the data communication transmit interactively a communication signal in real time with transmission velocity smaller than the broadcasting signal, and require a signaling channel for processing a call such as transmission/receipt of an address, etc, wherein information is exchanged only between limited users in the communications. In the remote controlling, a control signal is allowed to be delayed by a certain time. However, the remote controlling requires identifier ID system for separating stably control-devices and complete transmission quality so as to control assuredly the devices.

In addition, signals in applications having different characteristics should use the same frequency, and thus interference between the applications will be occurred. Accordingly, it is important to develop a protocol for preventing the interference with using the same frequency.

### DISCLOSURE OF INVENTION

### Technical Problem

Accordingly, the present invention is provided to substantially obviate one or more problems due to limitations and disadvantages of the related art.

First example embodiment of the present invention provides a wireless network protocol of converging broadcasting, communication and controlling for maintaining surely synchronization of devices so that collision is not occurred between the devices by setting differently frequencies or use time of the devices in a wireless communication.

Second example embodiment of the present invention provides a wireless network protocol of converging broadcasting, communication and controlling for maintaining a transmission delay time of below 20 msec so that a user does not sense transmission delay.

Third example embodiment of the present invention provides a wireless network protocol of converging broadcasting, communication and controlling having a signaling channel for supporting a call process, for connecting a call in several seconds for convenient of a user, and for performing future-oriented call process.

Fourth example embodiment of the present invention provide a wireless network protocol of converging broadcasting, communication and controlling for changing optionally transmission direction, transmission velocity, transmission output power, etc by assigning freely transmission time zone in accordance with use, and for supporting easily user interface though various applications are used.

### Technical Solution

A wireless network protocol for converging broadcasting, communication and controlling according to one example embodiment of the present invention includes setting one of wireless devices for transmitting/receiving at least one of the broadcasting, the communication and the controlling as a network group master device in a short ranged pico-cell; setting the other wireless devices as slave devices; maintaining synchronization between the wireless devices by transmitting a synchronization signal in a unit of a cycle, wherein the master device transmits the synchronization signal to the slave devices; transmitting repeatedly data with a certain period in a unit of specific cycle between the wireless devices; and changing a frequency in a unit of a frame.

The cycle includes one control frame and at least one payload frame, and has a length of below 20 msec so that length of a buffer used for voice/data communication when a broadcasting signal is transmitted/received has below 20 msec.

A plurality of cycles form a network cycle, and the control frames assigned in each of the cycles are set in accordance with a given uses in the network cycle.

The control frame and the payload frame include a lock time field set for synthesizing and stabilizing the frequency at an initial of the frame; a preamble field for transmitting/receiving the synchronization signal when data are transmitted/received; a tag field for transmitting/receiving data for specific use assigned to each of the frames, wherein a group code and a security code are not applied to the data; a message field for transmitting/receiving data, wherein the group code and the security code are applied to the data; and a frame tail information EoF field which is a time needed for state conversion of the modem and the RF module at end of the frame.

Length of the lock time field is below 245 μsec, data are not transmitted/received during the lock time, and a signal having 0 and a signal having 1 are repeatedly transmitted in turns to the RF module during the lock time when the modem has a transmission state.

Various kinds of preambles for separating the frames are existed in the protocol, wherein the preamble field is set in a unit of specific length.

The specific length equals to 128 μsec, and 127 kinds of preambles are existed in the protocol.

The tag field includes tag information having constant length and a CRC having constant length.

Length of the message field is constant in case that the frame is the control frame, and is set in a unit of a certain length by an upper layer in case that the frame is the payload frame.

The certain length is 8 μsec, and the CRC is selectively applied in the message field.

The frame tail information field is set in a unit of 1 μsec, and has length of above 42 μsec.

The network cycle includes a fast synchronization network cycle for setting rapidly synchronization of a slave device newly affiliated in the network group and a normal network cycle for maintaining normally the synchronization of the slave device in the network group, and wherein the normal network cycle is converted into the fast synchronization network cycle, or the fast synchronization network cycle is converted into the normal network cycle.

A control frame included in a cycle in the normal network cycle has a synchronization control frame SCF for maintaining synchronization of the slave device by transmitting information needed for the synchronization to the slave device from the master device, a request control frame RCF for sending request information to the master device from the slave device, a master control frame MCF for transmitting control information to the slave device from the master device, an acknowledge control frame RACF about the RCF, and an acknowledge control frame MACF/FCF about the MCF.

The normal network cycle has 16 cycles, and includes two SCFs, one RCF, one MCF, one RACF, eight MACF/FCFs and three preliminary control frames.

The fast synchronization network cycle has 16 cycles. Here, every control frame included in the cycles has a fast synchronization control frame FSCF for transmitting information needed for synchronization to the slave device from the master device so as to set rapidly the synchronization of the slave device.

A frame buffer related to the payload frame which is user data is included in the upper layer, and location information of a payload frame information table and operation modes of the payload frame are set by the upper layer.

The operation mode includes lock time information, preamble information, message information, frame tail information, CDMA/TDMA/ECC/CRC information and payload size information related to payload size transmitted from the upper layer.

A method of transmitting/receiving data in a wireless network for converging broadcasting, communication and controlling according to one example embodiment includes setting one of wireless devices for transmitting/receiving at least one of the broadcasting, the communication and the controlling as a network group master device in a short ranged pico-cell; setting the other wireless devices as slave devices; maintaining synchronization between the wireless devices by transmitting a synchronization signal in a unit of a cycle, wherein the master device transmits the synchronization signal to the slave devices; transmitting repeatedly data with a certain period in a unit of specific cycle between the wireless devices; and changing a frequency in a unit of a frame.

### ADVANTAGEOUS EFFECTS

A wireless network protocol of converging broadcasting, communication and controlling of the present invention is applied to devices in a pico-cell. As a result, a broadcasting signal, a communication signal and a control signal may be provided to the devices without interference by using the same system structure and the protocol. Hence, one device for converging broadcasting, communication and controlling is embodied with the wireless network protocol, and so the device may be used in application requiring various services such as future home network system or an ubiquitous city.

In addition, the protocol may be applied in new application such as a home system where a user calls the phone with listening to music, a mike system for a conference where users output simultaneously signals, an interactive tour guide system for receiving a question with providing announcement service, a client approval system for performing order approval with conversing with clients, and a group communication system where many people communicate simultaneously, etc. Hence, the protocol may be used as convenient tool in a future information communication field.

### BRIEF DESCRIPTION OF THE DRAWINGS

Example embodiments of the present invention will become more apparent by describing in detail example embodiments of the present invention with reference to the accompanying drawings, in which:

FIG. 1 and FIG. 2 are views illustrating synchronization maintenance and operation of a master device and a slave device in a system to which a wireless network protocol for converging broadcasting, communication and remote-controlling in a pico-cell is applied according to one example embodiment of the present invention;

FIG. 3 is a block diagram illustrating schematically structure of a network cycle, structure of a cycle and structure of a frame in the wireless network protocol according to one example embodiment of the present invention;

FIG. 4 is a block diagram illustrating structure of the frame in FIG. 3;

FIG. 5 is a block diagram illustrating structure of the cycle in FIG. 3;

FIG. 6 is a block diagram illustrating the control frame in the cycle in FIG. 3;

FIG. 7 is a block diagram illustrating the payload frame in the cycle in FIG. 3;

FIG. 8 is a block diagram illustrating the structure of the network cycle in FIG. 3;

FIG. 9 is a block diagram illustrating a synchronization use structure in the network cycle in FIG. 3 according to one example embodiment of the present invention

FIG. 10 is a block diagram illustrating conversion of the normal network cycle and the network cycle for only synchronization in the wireless network protocol according to one example embodiment of the present invention;

FIG. 11 is a view illustrating use of the request control frame RCF according to one example embodiment of the present invention;

FIG. 12 is a view illustrating use of the master control frame in the wireless network protocol according to one example embodiment of the present invention; and

FIG. 13 a view illustrating use of a buffer in each of frames in the wireless network protocol according to one example embodiment of the present invention.

M: master device S, S˜S3: slave device

### MODE FOR THE INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, a wireless network protocol of the present embodiment for converging broadcasting, communication and a remote-controlling transmits repeatedly data with a certain period in a unit of the same cycle between wireless devices for transmitting or receiving at least one of the broadcasting, the communication and the remote-controlling. Additionally, the wireless network protocol maintains synchronization between the wireless devices in a unit of the same cycle so that a frequency hopping is performed in a unit of a frame. Here, the wireless network protocol maintains synchronization in a unit of a cycle, thereby preventing collision between every wireless device. In addition, the wireless network protocol changes a frequency in a unit of a cycle so that a domestic and foreign frequency use regulations requiring a frequency hopping method are observed. In this case, a group master device for controlling synchronization is selected automatically or passively in a user group so as to maintain the synchronization in a unit of a cycle. The group master device transmits a synchronization signal with certain frequency at given time so that slave devices are synchronized.

To maintain the synchronization, information needed for the synchronization such as a use frequency and number of the cycle should be surely transmitted to the slave device from the master device. Hence, a control frame used by only the master device is included in the cycle, and so the master device transmits synchronization information to the slave device using the control frame.

Second, in the wireless network protocol of the present embodiment for converging broadcasting, communication and a controlling, length of the cycle is set to below 20 msec so that a buffer used for transmitting/receiving a broadcasting signal and a voice/data communication has length of below 20 msec. Here, it is desirable that the cycle has length of below 20 msec considering a delay time encoding or decoding.

Third, in the wireless network protocol of the present embodiment for converging broadcasting, communication and a controlling, a plurality of cycles form a network cycle. Here, control frames included in the cycles in the network cycle are differently assigned in accordance with their use, and so the control frames may be used for various controls.

Fourth, in the wireless network protocol of the present embodiment for converging broadcasting, communication and a controlling, a payload frame in the cycle used by a user may be set freely in the range of length of the cycle. In addition, the user may set optionally transmission direction, transmission velocity, transmission output power, etc in a unit of a frame and use the buffer in a unit of the frame. As a result, a user interface may be set simply.

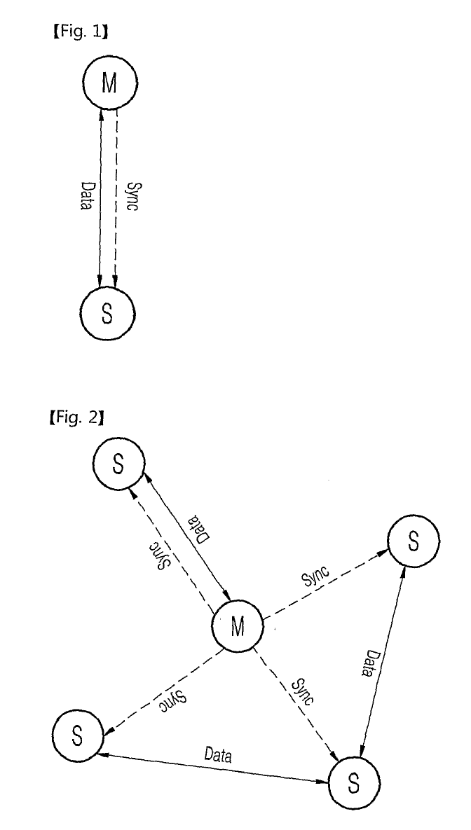

FIG. 1 and FIG. 2 are views illustrating synchronization maintenance and operation of a master device and a slave device in a system to which a wireless network protocol for converging broadcasting, communication and remote-controlling in a pico-cell is applied according to one example embodiment of the present invention.

The system of the present embodiment provides a point-to-point couple method as shown in FIG. 1 and a point-to-multi-point couple method as shown in FIG. 2.

The system in FIG. 1 includes one master device M and one slave device S. Here, the master device M transmits periodically a synchronization signal Sync to the slave device S. The slave device S communicates with the master device M, wherein the slave device S is synchronized with the master device M in accordance with the synchronization signal Sync.

The system in FIG. 2 has one master device M and a plurality of slave devices S. Here, the master device M transmits periodically a synchronization signal Sync to the slave devices S. The slave device S communicates (Data) with the master device M or other slave device S, wherein the slave devices S are synchronized with the master device M in accordance with the synchronization signal Sync. That is, the master device M transmits the synchronization signal Sync so as to maintain synchronization of a network, but does not relay communication between the slave devices S. In addition, one slave device S communicates directly with other slave device S with maintaining synchronization with the master device M. Here, Retaw control interface (hereinafter, referred to as “RCI”) to which the wireless network protocol is applied is in charge of a part of layers of the system. A physical RF module is disposed on a lowest-level layer of the system, and a modem is disposed on the RF module, wherein the modem is in charge of a baseband for exchanging RCI frame information with the RF module. Additionally, a RCI is disposed on the modem, and assists to embody the wireless application protocol by using a RCI command through a user does not know complicated RF control.

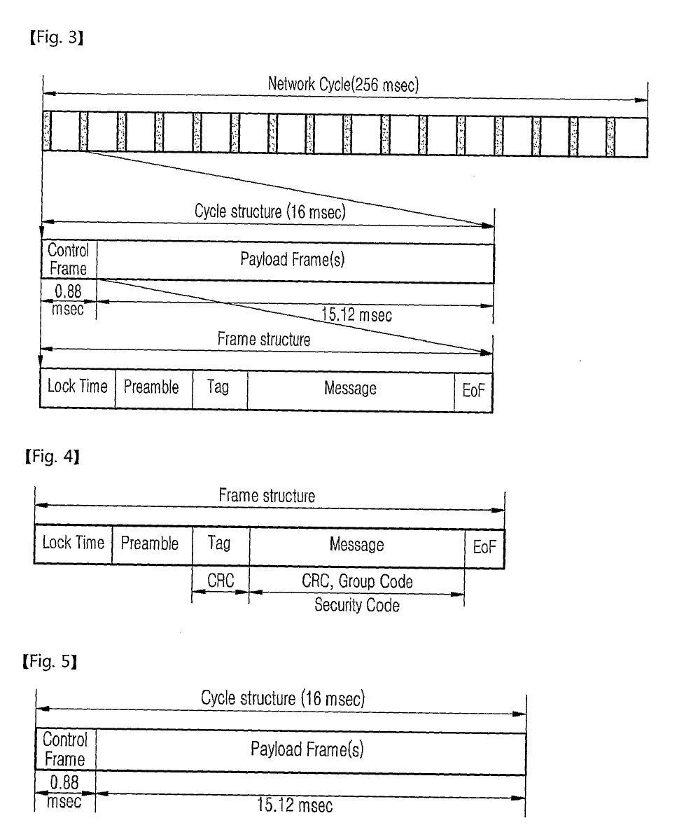

FIG. 3 is a block diagram illustrating schematically structure of a network cycle, structure of a cycle and structure of a frame in the wireless network protocol according to one example embodiment of the present invention.

The wireless network protocol of the present embodiment has structure of a network cycle having 256 msec as shown in FIG. 3.

The network cycle is made up of 16 cycles, wherein one cycle has a length of 16 msec, and includes a control frame having a length of 0.88 msec and at least one payload frame having a length of 15.12 msec.

FIG. 4 is a block diagram illustrating structure of the frame in FIG. 3.

The wireless network protocol of the present embodiment may change a transmission state in a unit of a frame. Here, one cycle has one control frame and at least one payload frame, wherein a length of the control frame is fixed, and a length of the payload frame may be variously changed in the range of 15.12 msec.

The frame in the wireless network protocol includes a lock time field, a preamble field, a tag field, a message field and a frame tail information EoF field as shown in FIG. 4.

The lock time field is set at the head of the frame for the purpose of synthesizing and stabilizing a frequency because the wireless network protocol is based on a wireless communication. That is, since the protocol may change the frequency and transmission/receipt mode in a unit of a frame, the Lock time field is needed for stabilizing a RF frequency synthesizer in a unit of the frame.

It is desirable that the lock time is below 245 μsec in the RF module. Here, it is impossible to transmit/receive data during the lock time. In case that the modem has a transmission state, a signal having 0 and a signal having 1 are repeatedly transmitted in turns to the RF module during the lock time. In case that the modem has a receipt state, data received during the lock time is disregarded.

The preamble field is in charge of transmitting or receiving the synchronization signal for synchronization of the frame when data are transmitted or received through a wireless communication. A length of the preamble is set by 128 μsec. For example, the preamble is generated by adding a code having a length of 127 bits to ‘0’ using a scan code having 7 bits, wherein the code is generated by a gold code generator. Here, the scan code used as seed of the preamble has range of 1 to 127. Generally, two devices can normally communicate only when the scan code between the devices is matched. This scan code has 127 kinds, and should be determined in advance prior to receiving of the frame. Accordingly, 127 kinds of the preamble fields are existed, and so the preamble fields may be used for separating the frames.

The tag field is in charge of transmitting or receiving data for specific use assigned to each of the frames, wherein a group code and a security code are not applied to the data. Since every device sees information included in the tag, the tag field may be used for the purpose of specifying distinctly use of the frame not certified by the preamble or used as a supplement signal such as a opened broadcasting channel signal, an accident signal, etc. A length of the tag is fixed as 32 μsec, and a cyclic redundancy check CRC having a length of 16 μsec is added to the tag. Here, the CRC is a result value obtained by applying a polynomial expression, e.g. CRC-CCITT, etc. to data included in the tag field.

The message field has data to which a group code and a security code are applied. In case of the control frame, the message field has fixed length. However, in case of the payload frame, the message field has a length set in accordance with a transmission mode by an upper layer.

In each of the frames, the CRC may be applied to the tag field, and be optionally applied to the message field. Here, the CRC applied to the message field a result value obtained by applying a polynomial expression, e.g. CRC-CCITT, etc. to data included in the message field.

The frame tail information EoF field is a time needed for state conversion of the modem and the RF module at end of the frame.

The frame tail information EoF field may be set in a unit of 1 μsec. Next frame follows the frame tail information EoF field. Here, it is desirable that the frame tail information field has above 42 μsec.

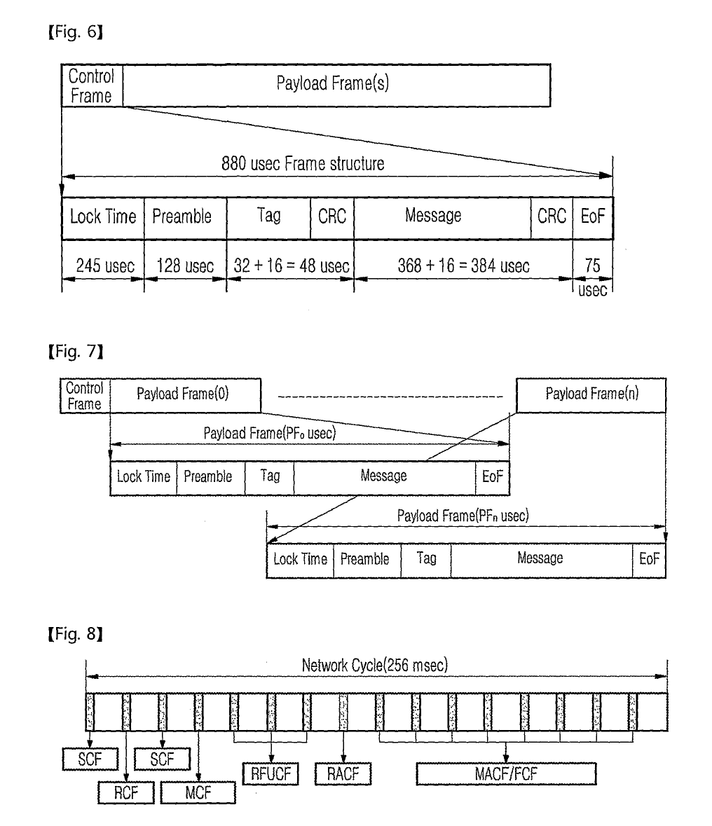

FIG. 5 is a block diagram illustrating structure of the cycle in FIG. 3.

One cycle includes a control frame and at least one payload frame. A length of the control frame is fixed as 880 μsec (0.88 msec). That is, the cycle should have the control frame having the length of 880 μsec (0.88 msec), and have at least one payload frame, wherein a number of the payload frames is less than 18. The number of the payload frames is set by an upper layer. In one example embodiment of the preset invention, sum of lengths of the payload frames equals to 15.12 msec.

FIG. 6 is a block diagram illustrating the control frame in the cycle in FIG. 3.

The control frame is in charge of transmitting/receiving control information, and may include synchronization information or control information of the upper layer.

On the other hand, every control frame has below structure.

The control frame includes a lock time field, a preamble field, a tag field, a message field and a frame tail information EoF field disposed in sequence like common frame.

The control frame has a length of 880 μsec, and includes the lock time field having a length of 245 μsec, the preamble field having a length of 128 μsec, a tag field (including CRC having a length of 16 μsec) having a length of 48 μsec, the message field (including CRC having a length of 16 μsec) having a length of 384 μsec, and the frame tail information EoF field having a length of 75 μsec.

The tag field in every control frame is made up of a tag information field having 4 bytes and the CRC having 2 bytes.

The message field includes a control message field having 46 bytes and the CRC having 2 bytes.

FIG. 7 is a block diagram illustrating the payload frame in the cycle in FIG. 3.

A number and a length of the payload frame in the cycle may be set corresponding to an application by an upper layer

The application may obtain various data rates in accordance with set of the payload frame.

In case that data are transmitted with high speed, overhead spent in each of frames may be reduced by adjusting the number of the payload frame. However, a transmission delay time is increased in proportion to a length of the frame by buffering.

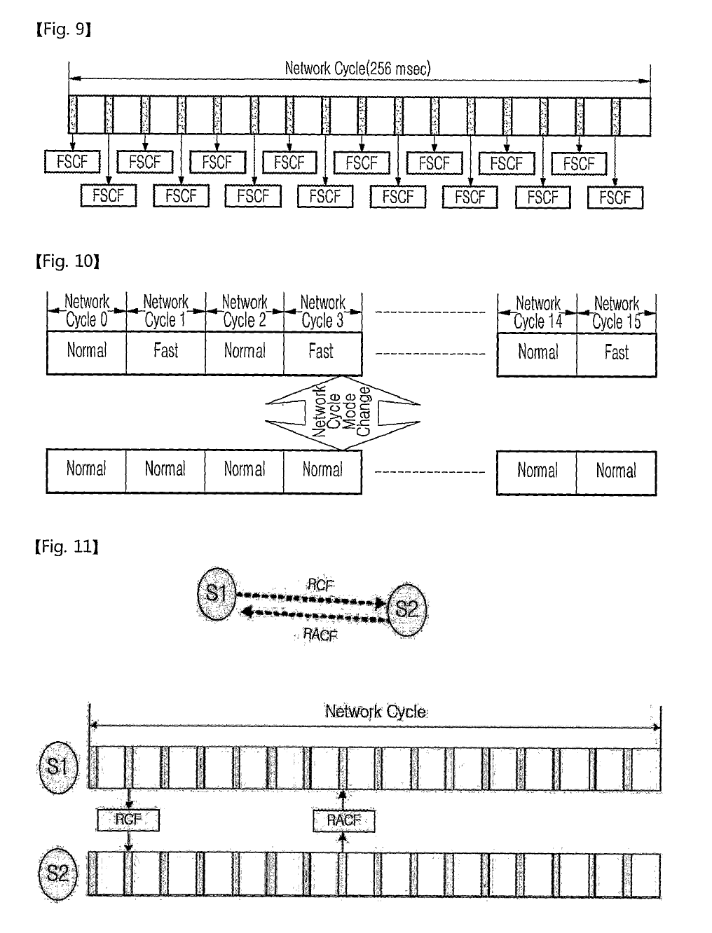

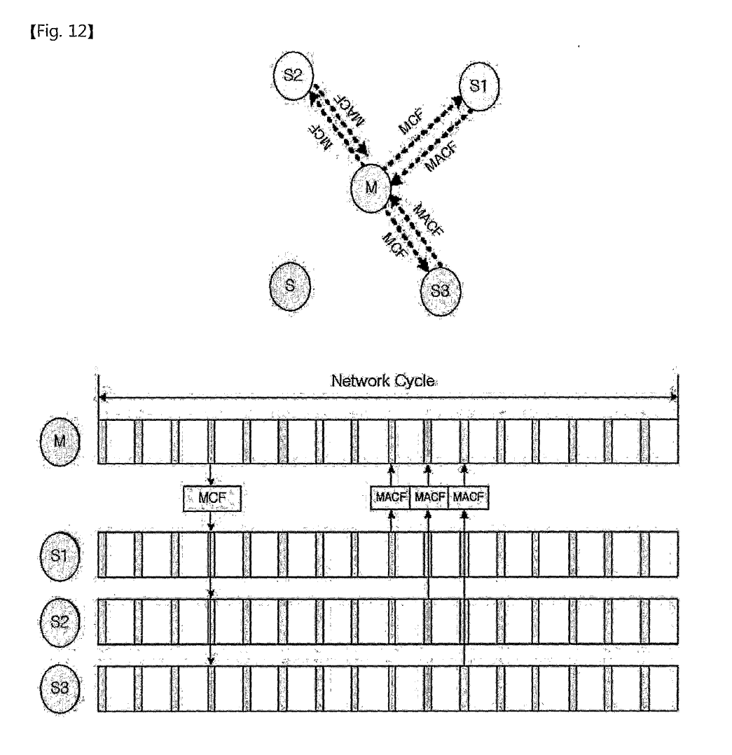

FIG. 8 is a block diagram illustrating the structure of the network cycle in FIG. 3. FIG. 9 is a block diagram illustrating a synchronization use structure in the network cycle in FIG. 3 according to one example embodiment of the present invention.

One network cycle has a length of 256 msec, and is made up of 16 cycles.

The network cycle has 16 control frames having a length of 0.88 msec. A part of the frames is used for control, wherein sum of lengths of partial frames equals to 14.08 msec. The other frames are used as the payload frame, wherein sum of lengths of the other frames equals to 241.92 msec.

The control frames have specific functions as shown in FIG. 8 and FIG. 9, respectively. The network cycle has a normal network cycle as shown in FIG. 8 and a fast synchronization network cycle as shown in FIG. 9.

As shown in FIG. 8, two control frames of 16 control frames are a synchronization control frame SCF, one control frame is a request control frame RCF for controlling to transmit request information from the slave device to the group master device, and one control frame is a master control frame MCF for controlling to transmit control information from the group master device to the slave devices. In addition, one control frame is an acknowledge control frame RACF for the RCF, 8 control frames are acknowledge control frames MACF/FCF for the MCF, and the other three control frames are control frames RFUCF reserved for the future.

The SCF is used for maintaining the synchronization. Two SCFs exist in one normal network cycle. The group master device transmits information for the synchronization, and the slave devices are synchronized in accordance with the SCF.

As shown in FIG. 9, in the fast synchronization network cycle, synchronization signals corresponding to every control frames are transmitted. That is, 16 fast synchronization control frames FSCF are transmitted.

A time required for set the synchronization may be reduced to several seconds in accordance with use of the fast synchronization network cycle when the initial synchronization is set according as the wireless device is joined in the network group.

FIG. 10 is a block diagram illustrating conversion of the normal network cycle and the network cycle for only synchronization in the wireless network protocol according to one example embodiment of the present invention.

In the wireless network protocol, the normal network cycle may be converted into the fast synchronization network cycle for fast synchronization, or the fast synchronization network cycle may be converted into the normal network cycle for fast synchronization. In case that every slave device is joined in the network group, i.e. in case that the synchronization is set, only the normal network cycle is used in the wireless network protocol. Here, number 0 is assigned to an initial cycle of the network cycle, and numbers increased in sequence by 1 are assigned in sequence to cycles following the initial cycle. As a result, number 15 is assigned to a final cycle of the network cycle. This numbering is used for separating the control frames.

In one embodiment of the present invention, the numbering is increased from 0 to 15, and then the above numbering process is repeatedly performed.

FIG. 11 is a view illustrating use of the request control frame RCF according to one example embodiment of the present invention.

Every device, i.e. group master device and slave devices in the group may transmit control information using the request control frame RCF.

The control information is information sent from an upper layer. The request control frame RCF between the slave devices is used for transmitting/receiving the control information.

Acknowledge about the request control frame RCF uses the acknowledge control frame for the RCF RACF.

Since a plurality of devices use the request control frame RCF, and thus the devices may access at the same time. Accordingly, the devices may be collided, and so a random back off should be performed by an upper layer so as to ensure reliability of the control information when the collision is occurred.

Every device in the group may transmit the RCF. Devices not transmitting the RCF should receive the RCF.

The devices in the group may transmit control information using the RACF.

The RACF is a control frame used as acknowledge about the control information received by using the RCF.

The device transmitting the RCF uses the RACF for the purpose of receiving acknowledge. The device receiving the RCF uses the RACF for the purpose of transmitting acknowledge.

The master device and the slave devices may transmit the RACF which is a control frame. In case that the upper layer transmits the RCF and then acknowledge about the RCF is not received to the upper layer despite the acknowledge should be received, the upper layer should be transmit again the RCF. In this case, the upper layer should transmit the RCF after performing random delay in a unit of the network cycle.

FIG. 12 is a view illustrating use of the master control frame in the wireless network protocol according to one example embodiment of the present invention.

The master control frame MCF may be used for transmitting control information by the master device in a group. Here, the control information is provided from the upper layer.

Acknowledge about the MCF is performed by the slave devices. In this case, the slave devices use eight acknowledge control frames for the MCF MACF.

The master device may transmit the control information to maximum 8 slave devices using one MCF. The slave devices may transmit acknowledge without colliding using the MACF.

The upper layer should control the MACF as acknowledge about the MCF. FIG. 12 shows that the master device M transmits the control information to the slave devices S1, S2 and S3. In this case, the upper layer should assign addresses about the slave devices S1, S2 and S3. The upper layer should determine order about MACF, i.e. determine that the acknowledge is transmitted at what order of the MACF.

The MACF may be used as acknowledge about the MCF by the slave devices, wherein the MACF is a control frame used when acknowledge about the control information related to the MCF is needed.

The MACF is used by the slave devices so as to transmit acknowledge about the MCF, and is used by the master device in order to receive the acknowledge about the MCF, wherein the master device transmits the MCF.

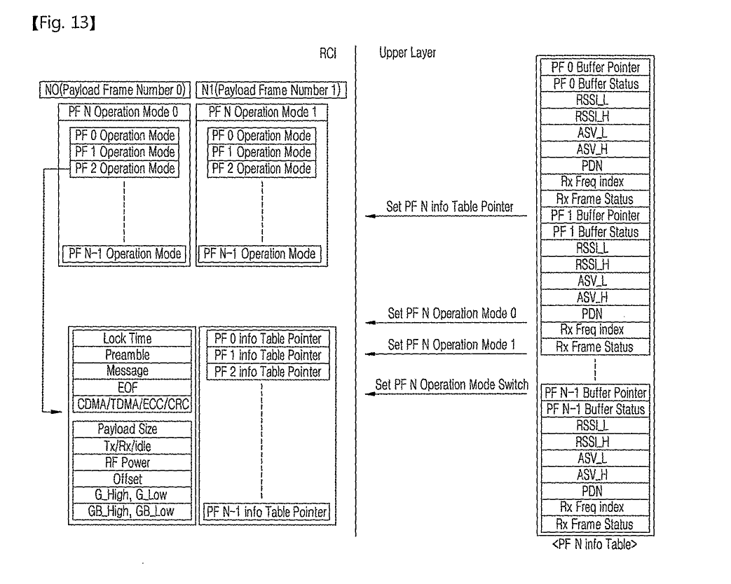

FIG. 13 a view illustrating use of a buffer in each of the frames in the wireless network protocol according to one example embodiment of the present invention.

Buffers are made in a unit of a frame in the upper layer for information exchange between a retaw control interface RCI and the upper layer. Here, the upper layer and the RCI share the buffers through a parameter passing method.

To avoid congestion phenomenon when the upper layer and the RCI use the buffer, two buffers having the same structure are used in turn.

A payload frame buffer exists in the upper layer. The upper layer sets location information of a payload frame information table (PF info table) and various operation modes of the payload frame to the RCI.

The operation mode of the payload frame includes lock time, preamble, message, EOF, CDMA/TDMA/ECC/CRC, payload size, Tx, Rx, Idle, RF power, Offset, G_High, G_Low, GB_High and GB_Low. Here, G_High and G_Low mean maximum value and minimum value of a threshold value when pattern of the preamble field is compared. In addition, GB_High and GB_Low indicate maximum value and minimum value of a threshold value about an invert value of a lowest preamble field when pattern of the preamble field is compared, wherein the payload frame has at least two preamble fields.

The upper layer provides the location information of the payload frame information table to the RCI. In this case, the upper layer sets number N of the payload frame.

The RCI may access the payload frame buffer of the upper layer using a payload frame information table pointer.

Hereinafter, the payload frame information table will be described in detail.

A payload frame N buffer pointer (PF N buffer pointer) means real location information of Nth payload frame buffer. For example, PF 0 buffer pointer in FIG. 13 indicates real location information of 0th payload frame buffer.

A payload frame N buffer status means status of the Nth payload frame buffer. Here, in case that the payload frame N buffer status is full status, this means that information to be transmitted to the buffer exists. However, in case that the payload frame N buffer status is empty status, this indicates that no information transmitted to the buffer exists.

A received signal strength indication RSSI means strength of a received frame when a corresponding payload frame is received.

An active sounding value ASV indicates an active sounding value of a received frame when a corresponding payload frame is received.

A preamble detect number PDN means preamble detect number of a received frame when a corresponding payload frame is received.

A received frequency index Rx Freq Index indicates a frequency of a received frame when a corresponding frame is received. That is, the RCI notes an index value of a frequency table used when the frame is received to the upper layer.

A received frame status Rx Frame Status means status of a received frame when a corresponding payload frame is received. This Rx Frame Status may include a CRC check result information and an interrupt information when the frame is received, etc. Here, in case that information of a Rx buffer in a modem is transmitted to the payload frame buffer, the transmitted information is not stored in the payload frame buffer but discarded when the payload frame buffer status is full status.

<Payload Frame Information Table Pointer Set Command (Set PF Info Table Pointer)>

The payload frame information table pointer set command is used for noting the location information of each of the payload frame information tables to the RCI when the upper layer is initialized. The RCI may access to the buffer included in the upper layer by using information of the payload frame information table pointer. In case that the payload frame is received, the RCI notes information concerning RSSI, ASV, PDN, Rx Freq Index, Rx Frame Status to the upper layer.

<Payload Frame Operation Mode 0/1 Set Command (Set Payload Frame Operation Mode 0/1)>

The payload frame operation mode 0/1 set command is used for setting the payload frame operation mode to the RCI by the upper layer.

Transmitting/receiving of the payload frame is determined when a link is set. In case that the link is released, the payload frame is set to idle status.

Hereinafter, fields of the payload frame operation mode will be described in detail.

N means number of the payload frame, for example has a value between 1 and 18.

A payload frame operation mode 0 (PF Operation Mode 0) manages preferentially information of payload frames to be applied.

A payload frame operation mode 1 (PF Operation Mode 1) is used when information of the payload frame having different structure from the payload frame operation mode 0 is needed.

The upper layer may change the structure of the payload frame using the payload frame operation modes 0/1, and use the changed payload frame. The changed frame structure is applied at an initial time of next cycle after a cycle where an operation mode conversion is request is finished.

The CDMA/TDMA/ECC/CRC field indicates information as to whether information of the payload frame relates to TDMA or CDMA, information as to whether or not ECC is used, and information as to whether or not the CRC is used. For example, the CDMA/TDMA/ECC/CRC field may be indicated with 3 bits. 1 bit of 3 bits indicates the information as to whether information of the payload frame relates to TDMA or CDMA, 1 bit indicates the information as to whether or not ECC is used, and the other 1 bit indicates the information as to whether or not the CRC is used.

The payload size field means size of the payload frame to be really transmitted from the upper layer.

The payload size may be different from sum of size of a tag field and size of a message field related to transmitting or receiving of the modem. In fact, the field related to transmitting or receiving of the modem corresponds to a time between initiation of the tag field and end of the message field. However, size of the payload frame to be really transmitted from the upper layer may be smaller than the sum of size of the tag field and size of the message field. Accordingly, the RCI writes information as much as size of the payload frame to the modem in case of a transmitter, and reads information as much as size of the payload frame.

The Tx/Rx/Idle field is set as idle when the payload frame is initialized, and is set as Tx or Rx when the link is set.

The RF power field may be individually set in each of the payload frames.

The Offset field assists the upper layer so that the upper layer can set individually offset every payload frame.

The G_High, G_Low, GB_High, GB_Low fields are used as a threshold value when pattern of the preamble is compared.

<Payload Frame Operation Mode Conversion Set Command (Set Payload Frame Operation Mode Switch)>

In case that structure of the payload frame is changed, the upper layer sets first information to the PF operation mode 0, and sets the second information different from the first information to the PF operation mode 1. In addition, the upper layer may execute the conversion set command so as to convert the PF operation modes.

The RCI converts the frame operation mode at a given time in case that the conversion set command is inputted. Here, in case that final payload frame of the network cycle is generated, the given time corresponds to an initial time of next network cycle when the payload frame operation mode conversion set command is requested, wherein the request of the payload frame operation mode conversion set command is detected through the flag.

In the payload frame operation mode operated presently, a part not affected to the structure of the frame of the operation mode may be changed. For example, Lock time, Preamble, Message, EOF and CDMA/TDMA/ECC/CRC may not be changed because Lock time, Preamble, Message, EOF and CDMA/TDMA/ECC/CRC affect to the structure of the frame. However, Tx/Rx/Idle, Offset, RF Power, G_High, G_Low, GB_High and GB_Low may be changed because Tx/Rx/Idle, Offset, RF Power, G_High, G_Low, GB_High and GB_Low affect to the structure of the frame.

<Payload Frame Number Set Command of the Operation Mode 0 (Set Payload Frame Number of Mode 0)>

The upper layer sets number of payload frames to be used in the operation mode 0 through the payload frame number set command of the operation mode 0. The number of the payload frame to be set is a value between 1 and 18.

<Payload Frame Number Set Command of the Operation Mode 1 (Set Payload Frame Number of Mode 1)>

The upper layer sets number of payload frames to be used in the operation mode 1 through the payload frame number set command of the operation mode 1. The number of the payload frame to be set is a value between 1 and 18.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A wireless network protocol for converging broadcasting, communication and controlling comprising:
setting one of wireless devices for transmitting/receiving at least one of the broadcasting, the communication and the controlling as a network group master device in a short ranged pico-cell;
setting the other wireless devices as slave devices;
maintaining synchronization between the wireless devices by transmitting a synchronization signal in a unit of a cycle, wherein the master device transmits the synchronization signal to the slave devices;
transmitting repeatedly data with a certain period in a unit of specific cycle between the wireless devices; and
changing a frequency in a unit of a frame.

2. The wireless network protocol of claim 1, wherein the cycle includes one control frame and at least one payload frame, and has a length of below 20 msec so that length of a buffer used for voice/data communication when a broadcasting signal is transmitted/received has below 20 msec.

3. The wireless network protocol of claim 2, wherein a plurality of cycles form a network cycle, and the control frames assigned in each of the cycles are set in accordance with a given uses in the network cycle.

4. The wireless network protocol of claim 2, wherein the control frame and the payload frame include a lock time field set for synthesizing and stabilizing the frequency at an initial of the frame; a preamble field for transmitting/receiving the synchronization signal when data are transmitted/received; a tag field for transmitting/receiving data for specific use assigned to each of the frames, wherein a group code and a security code are not applied to the data; a message field for transmitting/receiving data, wherein the group code and the security code are applied to the data; and a frame tail information EoF field which is a time needed for state conversion of the modem and the RF module at end of the frame.

5. The wireless network protocol of claim 4, wherein length of the lock time field is below 245 μsec, data are not transmitted/received during the lock time, and a signal having 0 and a signal having 1 are repeatedly transmitted in turns to the RF module during the lock time when the modem has a transmission state.

6. The wireless network protocol of claim 4, wherein kinds of preambles for separating the frames are existed in the protocol,
and wherein the preamble field is set in a unit of specific length.

7. The wireless network protocol of claim 6, wherein the specific length equals to 128 μsec, and 127 kinds of preambles are existed in the protocol.

8. The wireless network protocol of claim 4, wherein the tag field includes tag information having constant length and a CRC having constant length.

9. The wireless network protocol of claim 4, wherein length of the message field is constant in case that the frame is the control frame, and is set in a unit of a certain length by an upper layer in case that the frame is the payload frame.

10. The wireless network protocol of claim 9, wherein the certain length is 8 μsec, and the CRC is selectively applied in the message field.

11. The wireless network protocol of claim 4, wherein the frame tail information field is set in a unit of 1 μsec, and has length of above 42 μsec.

12. The wireless network protocol of claim 4, wherein the network cycle includes a fast synchronization network cycle for setting rapidly synchronization of a slave device newly affiliated in the network group and a normal network cycle for maintaining normally the synchronization of the slave device in the network group,
and wherein the normal network cycle is converted into the fast synchronization network cycle, or the fast synchronization network cycle is converted into the normal network cycle.

13. The wireless network protocol of claim 12, wherein a control frame included in a cycle in the normal network cycle has a synchronization control frame SCF for maintaining synchronization of the slave device by transmitting information needed for the synchronization to the slave device from the master device, a request control frame RCF for sending request information to the master device from the slave device, a master control frame MCF for transmitting control information to the slave device from the master device, an acknowledge control frame RACF about the RCF, and an acknowledge control frame MACF/FCF about the MCF.

14. The wireless network protocol of claim 13, wherein the normal network cycle has 16 cycles, and includes two SCFs, one RCF, one MCF, one RACF, eight MACF/FCFs and three preliminary control frames.

15. The wireless network protocol of claim 12, wherein the fast synchronization network cycle has 16 cycles,
and wherein every control frame included in the cycles has a fast synchronization control frame FSCF for transmitting information needed for synchronization to the slave device from the master device so as to set rapidly the synchronization of the slave device.

16. The wireless network protocol of one of claim 2 to claim 15, wherein a frame buffer related to the payload frame which is user data is included in the upper layer, and location information of a payload frame information table and operation modes of the payload frame are set by the upper layer.

17. The wireless network protocol of claim 16, wherein the operation mode includes lock time information, preamble information, message information, frame tail information, CDMA/TDMA/ECC/CRC information and payload size information related to payload size transmitted from the upper layer.

18. A method of transmitting/receiving data in a wireless network for converging broadcasting, communication and controlling comprising:
setting one of wireless devices for transmitting/receiving at least one of the broadcasting, the communication and the controlling as a network group master device in a short ranged pico-cell;
setting the other wireless devices as slave devices;
maintaining synchronization between the wireless devices by transmitting a synchronization signal in a unit of a cycle, wherein the master device transmits the synchronization signal to the slave devices;
transmitting repeatedly data with a certain period in a unit of specific cycle between the wireless devices; and
changing a frequency in a unit of a frame.
